(19) United States
(12) Patent Application Publication
(10) Pub. No.: US 2011/0000616 A1
(43) Pub. Date: Jan. 6, 2011

(54) ANTIMICROBIAL MELAMINE RESIN METHOD

(75) Inventors: WILLIAM D. HANRAHAN, Charlotte, NC (US); LAURIE J. PARIANO, Charlotte, NC (US); IVAN W. ONG, Charlotte, NC (US)

Correspondence Address: MICROBAN PRODUCTS COMPANY, 11400 VANSTORY DRIVE, HUNTERSVILLE, NC, 28078, US

(73) Assignee: MICROBAN PRODUCTS COMPANY, Huntersville, NC (US)

(21) Appl. No.: 12/829,998

(22) Filed: Jul. 2, 2010

Related U.S. Application Data
(62) Division of application No. 10/484,666, filed on Feb. 7, 2005.

(51) Int. Cl. B32B 37/02; B05D 3/02

(52) U.S. Cl. 156/307.5; 427/385.5

(57) ABSTRACT

The present invention relates to melamine resins having incorporated therein one or more antimicrobial agents capable of providing permanent antimicrobial properties to the resin. The melamine resin is compounded with the antimicrobial as a finely divided powder diluted in a liquid forming a dispersion. The compounded melamine resin is useful for making melamine based decorative laminates used floorings, countertops, dinnerware and other applications wherein a tough, mar resistant surface having bactericidal properties is required.

### BACKGROUND OF THE INVENTION

1) Field of the Invention

The present invention concerns an antimicrobial melamine resin useful in making surface coatings and decorative laminates particularly for countertops, flooring, tabletops, desktops, and molded products such as molded dinnerware, picnic dishes, and cups, as well as surface treatments for textile and paper. More particularly, the present invention concerns the addition to melamine resin of an antimicrobial agent, which is capable of quickly and uniformly dispersing within the resin and exhibits antimicrobial properties for the life of the melamine layer.

2) Prior Art

Melamine resins are well known and were first synthesized in 1834 by Liebig. Prior to about 1940, these resins were more a laboratory curiosity than a commercial product. Today, melamine resin is widely used for surface coatings and decorative laminates. Paper based laminates are sold under the trade names of Formica® and Micarta®. These types of coatings or decorative laminates are formed from photographic prints or decorative sculptured paper impregnated with melamine resin and placed on a core material and cured in a large press. The kraft paper impregnated with the melamine resin is very compatible with the melamine resin and costs less than multiple layers of impregnated paper.

Melamine resins have the hardest surface of any commercial material. This hard surface along with excellent grease and water resistance, low flammability, and clarity of the plastic has led to the usefulness of melamine formaldehyde as countertop material. These countertop materials are thin sheets composed of heavy paper or thin cardboard backing that is bonded to the backside of a patterned paper. The bonding material is usually phenolic, which may be foamed, but is not thick. The top layer is paper impregnated with melamine formaldehyde. The laminate is heated and subjected to pressure to attain a complete cure. The material generally is between two to four millimeters thick, up to about two meters in width, and sold as a roll in lengths. The roll sheet is then adhesively bonded to a wooden base to make countertop, flooring, furniture, etc.

The melamine resin is compatible with a wide variety of fillers and has been used for many molded parts because of the hard surface that results. Many products such as molded dinnerware, plastic dishes, and cups are made from the melamine resin which is hard, stain-resistant, and relatively low cost.

Prego® flooring is a ready to use (no sanding and no urethaning) laminated flooring system having a top layer of melamine formaldehyde that is heated under pressure to fuse to a wood layer. The top layer is a wear layer that is space age tough and yet transparent so that it allows the wood grain to show through.

Although melamine resins, and its uses such as with Formica® or dinnerware, etc., are well known to those skilled in the art, making melamine resin having antimicrobial properties is quite difficult.

Despite the difficulty, there is a need in the industry to create tabletops, countertops, dinnerware, and flooring, all of which could be used either in a residential or commercial setting. More specifically, a restaurant having Formica® tabletops, countertops in the kitchen, and flooring throughout the restaurant, all of which exhibit antimicrobial properties, would be desirable and would reduce the chances of contamination from salmonella, E. coli, and other bacteria and fungi. Because melamine resins are one of the hardest substances known, producing surfaces from melamine resins that have permanent antimicrobial characteristics, as opposed to a topical treatment that only has a temporary and very short-lived duration, has heretofore been unknown. Additionally, certain classes of antimicrobial agents are compatible or react with the melamine such that they are incorporated into the resin and no longer exhibit antimicrobial properties.

The need for dinnerware, picnic plates, cups, etc. also having antimicrobial properties exists for basically the same reasons given above with respect to surface countertops, tabletops and flooring. To create a melamine based resin having permanent antimicrobial properties such that the antimicrobial agent is capable of migrating through the very hard tough melamine resin, or is incorporated into the resin in such a manner that as the hard surface is abraded through normal wear and tear, newly exposed antimicrobial agent continuously renews the antimicrobial properties.

### SUMMARY OF THE INVENTION

The present invention relates to melamine resins having incorporated therein one or more antimicrobial agents capable of providing permanent antimicrobial properties to the resin.

In the broadest sense, the present invention relates to the combination of a permanent antimicrobial melamine resin comprising melamine and an antimicrobial agent which is substantially inert with respect to the melamine resin and is present within the melamine resin in an amount effective to provide antimicrobial properties.

The present invention also pertains to products made from melamine resin having the antimicrobial agent incorporated therein. In the broadest sense, the present invention relates to an article, such as dinnerware, cups, glasses, flooring, countertops, tabletops, and cutting boards, which exhibit permanent antimicrobial properties during the useful life of such articles.

### DESCRIPTION OF THE PREFERRED EMBODIMENTS

Melamine (C₃H₆N₆) is a white crystalline solid. Combining it with formaldehyde results in the formation of a compound referred to as methylol derivative. With additional formaldehyde (CH₂O) the melamine reacts to form tri-, tetra-, penta-, and hexamethylol-melamine. While commercial melamine resins may be obtained without the use of catalyst, both heating and catalyst are used to speed polymerization and curing. The reaction of the melamine with the formaldehyde is a condensation reaction with water as a byproduct. The curing of melamine resins is quickened by the use of heat and under neutral or slightly alkaline conditions to accelerate the curing. Additionally, the resin may contain fillers, plasticizers, dielectric modifiers, pigments or dyes, and glossing agents. When the resin is molded, the temperature range is generally between 310 to 340° F. (154-171° C.) and under pressure in a compression mold from 2000 to 5000 psi.

Decorative laminates are usually assembled with a core of several sheets of phenolic resin impregnated kraft paper. The core is surfaced with melamine formaldehyde impregnated sheet often printed with a decorative design. Finally, a thin melamine resin-impregnated overlay sheet is applied. The sheets are impregnated by being passed through a resin bath, and followed by controlled moisture drying. The assembly is laminated in a press at pressures ranging from 1000 to 1500 psi at temperatures ranging from 260 to 300° F. (127-149° C.). The laminates are mar resistant, and resistant to detergents, acids, alcohols, oils and greases.

Industrial melamine laminates offer excellent electrical resistance and heat stability properties and make excellent printed circuit board panels, for example.

When melamine formaldehyde is being used as a surface coating, on countertops, flooring, tabletops, etc., the antimicrobial agent of the present invention is incorporated into the bath through which the kraft paper passes, for example. When the melamine formaldehyde resin is employed to make molded articles such as dinnerware, cups, chopping blocks, etc., the antimicrobial agent is incorporated directly into the melamine molding resin.

Suitable antimicrobial agents for the present invention may be 2,4,4′trichloro-2′-hydroxydiphenyl ether (also known as triclosan); 2-phenylphenol; poly(hexamethylene biguanide) hydrochloride, 3,4,4′-trichlorocarbanilide, barium monohydrate, zinc omadine (derivatives of pyrithione), and zeolites containing copper, silver, and zinc and. Because several of these antimicrobial agents are capable of reacting with the melamine formaldehyde resin, they must consequently first be blended such that they are virtually encapsulated in a carrier that is compatible with melamine formaldehyde. This carrier containing antimicrobial agent is added to the melamine formaldehyde either in the bath when making solid surface materials or within the resin itself when compression molding. Generally, suitable carriers compatible with melamine formaldehyde are low-density polyethylene, crystalline polystyrene, and acrylics. More preferably, a master batch is produced using an antimicrobial agent and a suitable carrier. The concentration of the antimicrobial agent in the carrier is typically 10 to 40% by weight. Although the carrier range can be more or less than this amount, this amount is most suitable.

Alternatively, the antimicrobial agent may be incorporated into an emulsion or latex to be added to the liquid melamine formaldehyde coating/impregnation bath. The use of an emulsion or latex achieves two objects, protecting the agent from reaction through encapsulation in the minor component of the emulsion or latex, and preventing the separation or settling of the antimicrobial after mixing with the melamine formaldehyde resin prior to coating and curing.

To create a melamine formaldehyde resin having antimicrobial properties, it is generally preferred to have from about 0.1 to 5% by weight of the antimicrobial agent in the dried and cured resin. This loading of antimicrobial agent is high in most instances, but the thickness and hardness of the melamine formaldehyde is such that a high loading is necessary.

Generally during curing, formaldehyde is released from melamine formaldehyde resin. Formaldehyde itself is a good antibacterial agent. However, when the curing is completed, insufficient amounts of formaldehyde are released and with time the amount released is smaller and smaller such that it simply has no antimicrobial effect, particularly after about one year as a molded article or in a surface material. The present invention relates to the incorporation of an antimicrobial agent in the melamine formaldehyde resin such that it always has antimicrobial properties throughout its entire life.

What is claimed is:

1. A method for forming an antimicrobial overlay sheet for use in forming a laminate article, comprising:
supplying a melamine bath mixture including:
a melamine resin in an aqueous solution, and
an organic antimicrobial agent predispersed in a liquid dispersion, the organic antimicrobial agent selected from the group consisting of triclosan and a metal pyrithione;
immersing a substrate in the melamine mixture to substantially impregnate the substrate with the mixture; and
drying, at least partially, the impregnated substrate to form an overlay sheet having the organic antimicrobial agent disposed therein.

2. The method according to claim 1 wherein the organic antimicrobial agent in the melamine bath mixture has a concentration of from about 0.1% to about 0.5% based upon the weight of melamine resin.

3. The method according to claim 2 wherein the organic antimicrobial agent in the melamine bath mixture has a concentration of from about 0.3% to about 1.0% based upon the weight of melamine resin.

4. The method of claim 1 wherein the organic antimicrobial agent is triclosan.

5. The method of claim 1 wherein the organic antimicrobial agent is a metal pyrithione.

6. The method of claim 5 wherein the organic antimicrobial agent is zinc pyrithione.

7. The method according to claim 1 wherein the melamine resin is a melamine, a methylated melamine, a butylated melamine, or an isobutylated melamine.

8. A method for manufacturing an antimicrobial laminate article, comprising:
forming a pre-cured laminate by assembling:
a melamine-formaldehyde impregnated overlay sheet,
a melamine-formaldehyde impregnated printed paper sheet, and
a fiberboard,
wherein the melamine-formaldehyde impregnated overlay sheet is formed by the method of claim 1; and
curing the pre-cured laminate assembly by heating with pressure for at least 15 seconds at a temperature of from about 127° C. to about 290° C. and under a pressure of from about 1000 psi to about 5000 psi;
wherein the organic antimicrobial agent is permanently disposed at or near a surface of the manufactured laminate article defined by the melamine-formaldehyde impregnated overlay sheet, such that the surface has antimicrobial efficacy for the useful life of the manufactured laminate article.

9. The method according to claim 8 wherein the organic antimicrobial agent in the melamine-formaldehyde impregnated overlay sheet has a concentration of from about 0.1% to about 0.5% based upon the weight of melamine resin.

10. The method according to claim 9 wherein the organic antimicrobial agent in the melamine-formaldehyde impregnated overlay sheet has a concentration of from about 0.3% to about 1.0% based upon the weight of melamine resin.

11. The method of claim 8 wherein the organic antimicrobial agent is triclosan.

12. The method of claim 8 wherein the organic antimicrobial agent is a metal pyrithione.

13. The method of claim 12 wherein the organic antimicrobial agent is zinc pyrithione.

14. The method according to claim 8 wherein the melamine resin is a melamine, a methylated melamine, a butylated melamine, or an isobutylated melamine.
